(19) United States
(12) Patent Application Publication
(10) Pub. No.: US 2005/0268558 A1
(43) Pub. Date: Dec. 8, 2005

(54) Window regulator slider and vehicle window regulator equipped with a window regulator slider

(76) Inventors: Patrice Cardine, Orleans (FR); Denis Chevy, Neuvy En Sullias (FR)

Correspondence Address: CARLSON, GASKEY & OLDS, P.C., 400 WEST MAPLE ROAD, SUITE 350, BIRMINGHAM, MI, 48009, US

(21) Appl. No.: 11/129,206

(22) Filed: May 13, 2005

(30) Foreign Application Priority Data
Jun. 4, 2004 (FR) 04 06 069

(51) Int. Cl. E05F 15/08

(52) U.S. Cl. 49/349

(57) ABSTRACT

A slider for a vehicle window regulator includes a rail passage for a guide rail that runs in a “Z” direction and which guides the slider while the window is being raised and lowered. The slider includes a securing member that passes through a hole in a window glass for securing the window glass to the slider. The position at which the securing member and window glass are locked to the slider is adjustable in the “Z” direction. The slider allows adjustment to be readily performed and ensures the vehicle window glass has a good seal with a vehicle roof when the vehicle window glass is in the fully raised position, especially in a frameless door.

### REFERENCE TO RELATED APPLICATIONS

This application claims priority to French Patent Application FR 04 06 069 filed on Jun. 4, 2004.

### BACKGROUND OF THE INVENTION

The present invention relates generally to a slider for a vehicle window glass regulator, a window regulator incorporating a slider, and a part of a bodywork of a vehicle incorporating the window regulator.

The position of a window regulator mounted in a vehicle needs to be adjusted so that a window glass can be raised and lowered to an upper position and a lower position. Adjusting the window regulator causes a problem in frameless doors where the window glass is not guided by lateral slideways during movement. Adjustment includes locating the window glass at the correct position, and the various adjustments are generally performed on the window regulator. The window glass is adjusted at the raised position when the window glass meets a vehicle roof and the mechanism is at the top position of travel.

French patent 2,815,667 discloses a system for securing a window regulator on a frameless door. A front edge of a window glass is guided by a slideway which extends from inside the door outwardly. The window regulator includes a forward rail and a rear rail substantially parallel to the slideways. Sliders slide on the rails. Adjustment in the heightwise direction of the vehicle is done on the front rail by securing the front rail to the slider and on the rear rail by adjusting the actual slider. The problem with adjusting this type of window regulator is that various adjustment systems for each of the front rail and the rear rail are employed, thereby increasing window regulator production costs. Secondly, the system disclosed does not adapt to all door configurations, and it is not always possible to secure the forward rail onto the forward guiding slider.

There is consequently a need for less expensive means of adjusting a window regulator.

### SUMMARY OF THE INVENTION

The present invention provides a slider for a vehicle window regulator including a rail passage for a guide rail extending in a defined direction and a securing member for securing a window glass to the slider. The securing member is movable in the defined direction of the rail passage of the guide rail.

According to one embodiment, the securing member can be immobilized with respect to the slider. According to a further embodiment, the securing member can be reversibly immobilized with respect to the slider. According to a further embodiment, the slider includes a slot, and the securing member is guided in translation by the slot. According to yet a further embodiment, the securing member includes a bush and a screw, and the securing member is immobilized with respect to the slider by tightening the screw in the bush. According to a further embodiment, the securing member is immobilized with respect to the slider by bringing the screw against one face of the slider and by bringing the bush against a second face of the slider.

The present invention also provides a vehicle window regulator including a guide rail and a slider guided in translation by the guide rail. A vehicle bodywork element includes the window regulator, and a window glass is secured to the window regulator by the slider.

A method for adjusting a window glass on a window regulator includes the steps of assembling a window glass to a securing member, adjusting a position of the securing member in the direction in which the slider is guided by a guiding rail, and immobilizing the securing member with respect to the slider.

Preferably, the method also includes the step of inserting a window regulator into a vehicle bodywork element. The step of assembling the window glass is performed after the step of inserting the window regulator into the vehicle bodywork element. The step of adjusting the position of the securing member is performed with the slider at an uppermost position of abutment along the guide rail.

Further characteristics and advantages of the invention will become more clear from the detailed description which follows of some embodiments, provided solely by way of example and with reference to the attached drawings.

### BRIEF DESCRIPTION OF THE DRAWINGS

FIG. 1 is a front view of a slider according to one embodiment;

FIG. 2 is a cross-sectional view through the slider taken along line A-A;

FIG. 3 is a cross-sectional view through the slider taken along line B-B; and

FIG. 4 is a perspective view of the slider.

### DETAILED DESCRIPTION OF PREFERRED EMBODIMENTS

A slider for a window regulator includes a rail passage for a slider guide rail. The slider also includes a securing member for securing a window glass to the slider that is movable in the direction of the rail passage. The slider ensures simple adjustment of the window glass, thereby offering a relatively inexpensive structure. The slider makes it possible to reduce the cost of window regulator production.

Below, the direction X represents the direction in which the vehicle is moving, the direction Y is a direction perpendicular to direction X in the plane of forward movement of this vehicle, and the Z direction is the direction in which the window glass moves.

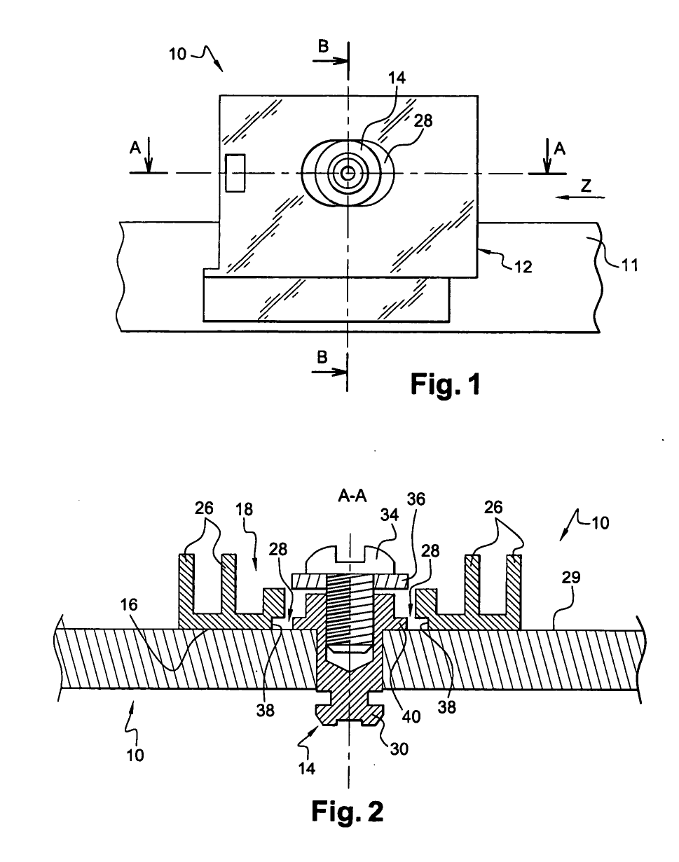

FIG. 1 shows a slider 10 and a guide rail 11. The guide rail 11 extends in the Z direction and guides the slider 10 in that direction. The slider 10 includes a rail passage 12 for the guide rail 11. The rail passage 12 can be seen in FIG. 4, which is a perspective view of the slider 10. In FIG. 1, the slider 10 moves from left to right. The slider 10 also includes a securing member 14 for securing a window glass 29 to the slider 10. The slider 10 is movable in the Z direction of the rail passage 12. Thus, in FIG. 1, the securing member 14 is movable from left to right, allowing the position at which the window glass 29 is secured to the slider 10 to be shifted in the Z direction.

The guide rail 11 guides the movement of the slider 10 in the Z direction in the vehicle, in other words up and down and vice-versa. The guide rail 11 includes a wing portion having a shape adapted to penetrate into the passage 12 of the slider 10. The guide rail 11 is, for example, a stamped or shaped metal plate. The guide rail 11 can include upper and lower stops against which the slider 10 comes into abutment at the top and bottom of its travel in the vehicle bodywork.

The slider 10 provides a connection between the window glass 29 and the mechanism for driving the window regulator. The slider 10 allows the window glass 29 to slide in the Z direction. In FIG. 4, the slider 10 has a flat face 16 against which the window glass 29 rests and a second face 18 opposite to the flat face 16 on which the rail passage 12 is located. The rail passage 12 is shown in FIG. 4 with, by way of example, two lugs 20 and 22 that are distanced from the second face 18 and extend parallel to the faces 16 and 18 and perpendicular to the Z direction. The slider 10 also includes a plane 24 extending from the second face 18 and perpendicularly to the Z direction. The lugs 20 and 22 extend towards the plane 24, together defining the rail passage 12 for the guide rail 11 with the plane 24 and the second face 18. As shown in FIG. 4, the rail passage 12 has an L-shape, and the two arms of the L-shape prevent rotation in the X and Y directions with respect to the guide rail 11 during sliding. The lugs 20 and 22 are distanced at each end of the slider 10 in the Z direction to ensure stability of the slider 10 along the guide rail 11. Ribs 26 along the lugs 20 and 22 provide greater rigidity for the lugs 20 and 22.

The securing member 14 allows the window glass 29 of the window regulator to be secured to the slider 10. The securing member 14 can be moved linearly in the Z direction, making it possible to adjust the position at which the window glass 29 is secured in the direction in which the window glass 29 is raised or lowered while the slider 10 is immobilized along the guide rail 11. In particular, the securing member 14 allows the position at which the window glass 29 is secured to the slider 10 in the direction of movement to be adjusted with respect to the vehicle roof, thereby ensuring correct positioning of the window glass 29 when it comes to the end of its upward travel. Preferably, the position of the window glass 29 is adjusted in general when the window glass 29 is in the upper raised position when the slider 10 is immobilized against an upper abutment stop. The securing member 14 can also be immobilized with respect to the slider 10 when the window glass 29 is adjusted in position in a vehicle. The securing member 14 can have its position adjusted with respect to the slider 10 on the window regulator production line. Alternatively, the securing member 14 can be adjusted in position with respect to the slider 10 once the window regulator has been mounted in a vehicle both while the vehicle is being produced as well as later if it is necessary to replace a broken window glass. The securing member 14 can in particular be employed in place of a gripper-type slider which includes a jaw that grips the window glass 29. The latter type of slider has a complex structure and is expensive. Using the slider 10 of the invention consequently reduces costs. The invention can obviously be applied to other shapes or means for securing a window glass to a slider.

One non-limiting example of an embodiment of the securing member 14 and of how the securing member 14 can be shifted with respect to the slider 10 will now be described. In FIG. 4, the securing member 14 is a pin extending transversely to the faces 16 and 18 and to the window glass 29. As shown in FIG. 1, the slider 10 includes a slot 28 running perpendicularly to the faces 16 and 18 of the slider 10. The slot 28 guides translatory movement of the securing member 14, and the securing member 14 can be moved in translation in the Z direction. The slot 28 is an oblong hole, and the major axis runs in the Z direction. The side walls of the slot 28 guide translatory movement of the securing member 14. As shown in FIG. 1, the securing member 14 is located substantially at the center of slot 28. Spaces are at each side of the securing member 14 between the securing member 14 and the end walls of the slot 28, indicating how the securing member 14 can be moved with respect to the slider 10 in either direction on the Z-axis.

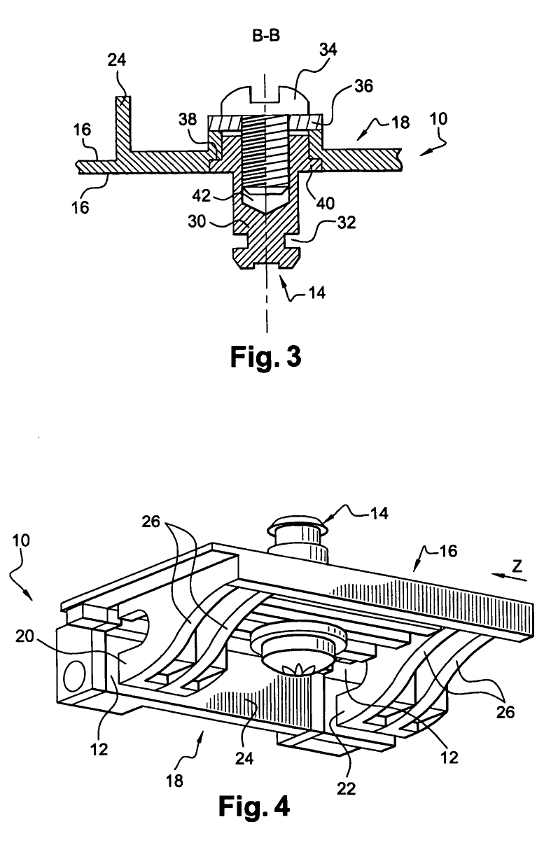

FIG. 2 is a sectional view of the slider 10 taken along line A-A of FIG. 1. FIG. 2 shows the flat face 16 against which the window glass 29 lies and the second face 18 opposite the flat face 16, with the ribs 26 ensuring rigidity for the lugs 20 and 22. The securing member 14 for the window glass 29 is also shown. The securing member 14 includes a bush 30 or dowel pin passing through the slider 10 orthogonally to the faces 16 and 18. The bush 30 also penetrates into the window glass 29 to retain it in position. A passage through the window glass 29 can be provided for this purpose. One of the ends of the bush 30 passes through the window glass 29. A grommet can be placed in the passage through the window glass 29, allowing some play between the slider 10 and the window glass 29 in the X direction to avoid excessive rigidity of guiding of the window glass 29 in the X direction. A groove 32 can be provided at the end for receiving a forked retainer (not illustrated) for the window glass 29. The forked retainer locks the window glass 29 and the securing member 14 together and ensures the window glass 29 is held firmly against the flat face 16. The securing member 14 further includes a screw 34 and a washer 36 for immobilizing the securing member 14 with respect to the slider 10. The screw 34 and the washer 36 will be described in relation with FIG. 3.

In FIG. 2, the slot 28 provides spaces visible between the securing member 14 and the slider 10, and the securing member 14 can be shifted in the Z direction to occupy one or the other of the spaces, thereby allowing the window glass 29 to be adjusted in the Z direction. For example, the range of adjustment between the securing member 14 and the slider 10 can be of the order of +/−4 mm. Further, an undercut 38 is formed at the circumference of the slot 28. The undercut 38 is a groove at the circumference of the mouth of the slot 28 and facilitates guiding of the securing member 14 in the Z direction. The undercut 38 is on the flat face 16 of the slider 10 and cooperates with a shoulder 40 of the bush 30, as will be described in relation with FIG. 3.

FIG. 3 shows a sectional view of the slider 10 taken along line B-B of FIG. 1. In FIG. 3, the flat face 16 against which the window glass 29 rests, the second face 18 opposite to the flat face 16, and the plane 24 of the guide rail passage 12 are shown. The securing member 14 for the window glass 29 can also be seen, the window glass 29 not being illustrated. The securing member 14 includes the bush 30, the screw 34 and the washer 36. In this cross-section, the slot 28 guides movement of the securing member 14 in the Z direction towards one or the other of the spaces visible in FIG. 2 that are between the securing member 14 and the slider 10. The shoulder 40 of the bush 30 slides along the undercut 38.

FIG. 3 shows how the securing member 14 is immobilized with respect to the slider 10. The bush 30 is inserted via the flat face 16 into the slot 28 until the shoulder 40 abuts the undercut 38. The bush 30 now projects from the flat face 16. The pin includes a thread 42 at one end that comes to the surface towards the second face 18 of the slider 10. The screw 34 is inserted into the thread 42 and abuts the second face 18 via the washer 36. The slider 10 is clamped when the screw 34 is tightened into the bush 30, bringing the screw 34 against the flat face 16 of the slider 10 (via the washer 36) and the bush 30 against the second face 18 of the slider 10 (via the shoulder 40 and the undercut 38). This ensures that the securing member 14 is immobilized with respect to the slider 10 along the Z direction.

The securing member 14 can be immobilized with respect to the slider 10 in a reversible fashion. This allows the position of the window glass 29 with respect to the slider 10 to be pre-set and then definitively adjusted once in the vehicle. It also allows the window glass 29 to be removed for replacement. Reversible immobilization or locking is, for example, made possible by the screw 34, which can be screwed into and out of the bush 30.

Further, the cooperation between the undercut 38 and the shoulder 40 prevents the securing member 14 from deviating in the Z direction. Allowing for tolerances, the securing member 14 can substantially only move with respect to the slider 10 in the Z direction. Further, the undercut 38 makes it possible to embed the shoulder 40 of the bush 30 in the flat face 16 so that the flat face 16 provides a continuous flat surface to ensure the window glass 29 lies flat against the slider 10.

The invention also provides a window regulator including a guide rail 11 and a slider 10 as discussed above, and the slider 10 is guided in translation by the guide rail 11. The slider 10 is, for example, driven linearly by a cable that is itself driven by a geared motor or a winder. The window regulator can further include a second guide rail, and each of the rails guide the slider 10 in translation. One of the sliders can be the slider 10 described above or alternatively both can be the slider 10 described above. Using the same type of slider makes it possible to reduce window regulator production costs.

The window regulator can be mounted in an element of a vehicle bodywork as well as on a window glass secured to the window regulator by the slider 10. The window glass 29 can be assembled onto the window regulator only after the window regulator has been mounted in the bodywork element. Alternatively, the window glass 29 can be secured to the window regulator before the window regulator is mounted in the bodywork element. This is, for example, the case when the window glass 29 has been broken and needs replacement. The slider 10 as described allows the height (Z direction) adjustment of the window glass 29 with respect to the slider 10 without needing to shift the guide rail 11 in this direction, as was the case in French patent 2,815,667. Thus, the slider 10 can be fastened at its ends to the bodywork element, after which the position of the window glass 29 is adjusted. Adjustment of the window glass 29 with respect to the slider 10 is easier to perform than the adjustment of the guide rail 11 with respect to the vehicle door.

The invention also provides a method for adjusting a window glass 29 on a window regulator. The method can be applied to the adjustment of a window glass 29 with respect to a window regulator already mounted in a bodywork element, such as a vehicle door or a rear side panel, or to the adjustment of a window glass 29 with respect to a window regulator on a window regulator assembly line. The window regulator includes the slider 10 as described above. Without this being limiting, the method involves bringing the slider 10 to its upper point of abutment, allowing the window regulator to be adjusted with the window glass 29 at its highest position. This is the most critical position to adjust because, in this position, the window glass 29 must cooperate with the vehicle roof to ensure good sealing of the passenger compartment. Bringing the slider 10 to the upper position of abutment is, for example, achieved by providing a mechanical stop member along the guide rail 11. This can, for example, be a rivet riveted into the guide rail 11. The stop member is positioned so that the slider 10 is prevented from continuing to move along the guide rail 11.

Next, the method involves the step assembling the window glass 29 onto the securing member 14. Taking the embodiment of the securing member 14 described above, the step of assembling the window glass 29 includes inserting a bush 30 through the window glass 29 or the grommet and preferably locking the window glass 29 to the securing member 14 via a forked retainer. The locking of the window glass 29 to the securing member 14 makes it easier to adjust the securing member 14 without detaching the window glass 29.

The method also includes the step of adjusting the position of the securing member 14 in the direction of guiding the slider 10 by the guide rail 11. In particular, adjusting the position of the securing member 14 is determined by adjusting the position of the window glass 29 in its direction of raising and lowering with respect to the vehicle roof. This step ensures good positioning of the window glass 29 at its highest travel position, notably to ensure good sealing between the window glass 29 when it is raised and the vehicle roof.

The method also includes the step of immobilizing the securing member 14 with respect to the slider 10. This ensures the securing member 14 is held at the desired adjusted position. Immobilization is, for example, achieved by tightening the screw 34 into the bush 30. For immobilizing the position of the securing member 14 onto the slider 10, the window regulator will be at its highest position, with the window glass 29 on the jig or vehicle and the securing member 14 passing through the window glass 29.

The method can also be applied to adjusting the window glass 29 with respect to a window regulator in a bodywork element. The method includes the steps of inserting a window regulator into a bodywork element. The step of assembling the window glass 29 to the securing member 14 can then be performed after the window regulator has been inserted into the bodywork element. The step of adjusting the position of the securing member 14 can be done with the slider 10 at its uppermost position along the guide rail 11. This allows appropriate securement of the window glass 29 in its position of cooperation with the vehicle roof to ensure sealing of the passenger compartment.

It can also be envisioned to insert the window regulator into the bodywork element with the window glass 29 already assembled. In this case, the previous immobilizing step can be reversible. The securing member 14 is now released from its immobilized position, adjusted to the appropriate position by moving the slider 10 on the guide rail 11 in the guiding direction and then again immobilized. The previous adjustment step is now only a pre-adjustment step, facilitating insertion of the window regulator and the window glass 29 into the bodywork element. The new adjustment step allows the window glass 29 to be adjusted in the Z direction with respect to the bodywork element.

Obviously, this invention is not limited to the embodiments described by way of example. Thus, the slider described could for example be employed for a window glass of a sliding roof.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

1. A slider for a vehicle window regulator comprising:
a passage for a guide rail, the passage extending in a defined direction; and
a securing member for securing a window glass to the slider, wherein the securing member is movable in the defined direction.

2. The slider according to claim 1, wherein the securing member is immobilized with respect to the slider.

3. The slider according to claim 1, wherein the securing member is reversibly immobilized with respect to the slider.

4. The slider according to claim 1, wherein the slider includes a slot, and the securing member is guided in translation by the slot.

5. The slider according to claim 1, wherein the securing member includes a bush and a screw, and the securing member is immobilized with respect to the slider by tightening the screw in the bush.

6. The slider according to claim 5, wherein the slider includes a first face and a second face and the securing member is immobilized with respect to the slider by bringing the screw against the first face of the slider and by bringing the bush against the second face of the slider.

7. A vehicle window regulator comprising:
a guide rail;
a slider including a passage for the guide rail, the passage extending in a defined direction, wherein the slider is guided in translation by the guide rail; and
a securing member for securing a window glass to the slider, wherein the securing member is movable in the defined direction.

8. A vehicle bodywork element comprising:
a window regulator including a guide rail;
a slider including a passage for the guide rail, the passage extending in a defined direction, wherein the slider is guided in translation by the guide rail;
a securing member for securing a window glass to the slider, wherein the securing member is movable in the defined direction; and
the window glass secured to the window regulator by the slider.

9. A method for adjusting a window glass on a window regulator comprising the steps of:
assembling the window glass to a securing member that secures the window glass to a slider;
adjusting a position of the securing member in a defined direction, wherein the slider includes a passage for the guide rail that extends in the defined direction and the slider is guided in translation by the guide rail in the defined direction; and
immobilizing the securing member with respect to the slider.

10. The method according to claim 9, further including the step of inserting the window regulator into a vehicle bodywork element, wherein the step of assembling the window glass is performed after the step of inserting and the step of adjusting the position of the securing member is performed with the slider at an uppermost position of abutment along the guide rail.
